(19) United States
(12) Patent Application Publication
(10) Pub. No.: US 2026/0177815 A1
(43) Pub. Date: Jun. 25, 2026

(54) IDENTIFYING REFLECTION CHANGES TO DETERMINE EYE MOVEMENT

(71) Applicant: GOOGLE LLC, Mountain View, CA (US)

(72) Inventors: Clayton Merrill Kimber, Raharney (IE); Andrew Logan, Waterloo (CA)

(21) Appl. No.: 19/427,486

(22) Filed: Dec. 19, 2025

Related U.S. Application Data
(60) Provisional application No. 63/738,065, filed on Dec. 23, 2024.

(51) Int. Cl. G02B 27/00; G02B 27/01

(52) U.S. Cl. CPC G02B 27/0093; G02B 27/0172; G02B 2027/0138; G02B 2027/014

(57) ABSTRACT

According to at least one implementation, a method includes displaying content on an extended reality device and capturing, by a camera, a reflection from an eye of a user, the camera configured to asynchronously identify changes to pixels in the reflection. The method further includes detecting a movement of the eye based on a change to at least one pixel detected in the reflection.

### CROSS-REFERENCE TO RELATED APPLICATION

This application claims the benefit of U.S. Provisional Application No. 63/738,065, filed Dec. 23, 2024, the disclosure of which is incorporated herein by reference in its entirety.

### BACKGROUND

An extended reality (XR) device is a type of wearable technology, such as a headset or glasses, that blends the real and virtual worlds. This category includes virtual reality (VR) devices, which completely immerse a user in a computer-generated environment, and augmented reality (AR) devices, which overlay digital information onto the user's view of the physical world. Mixed reality (MR) devices go a step further by allowing virtual objects to interact with the real environment. XR technology is used in a wide range of applications, from gaming and entertainment to education, professional training, and remote collaboration.

To enhance user interaction, many XR devices incorporate eye tracking technology. Eye tracking is a process that monitors and measures a person's eye movements to determine where they are looking, often referred to as their point of gaze. A common method for implementing eye tracking in an XR headset involves using small cameras and infrared light sources mounted inside the device. These lights illuminate the user's eyes, creating specific reflection patterns. The cameras capture these reflections, and a computer system analyzes the patterns to calculate the precise direction of the user's gaze. This allows for more intuitive control and interaction within the virtual or augmented environment.

### SUMMARY

The described systems and methods provide a power-efficient means to track eye movement in an extended reality device. Light from the device display is used to illuminate an eye of a user, creating a reflection. A special type of camera, such as a neuromorphic or event camera, captures this reflection. This camera operates asynchronously, detecting changes in light on a pixel-by-pixel basis rather than capturing full frames at a fixed rate. A processing system can then detect eye movement by analyzing changes in the reflection that are not correlated with known updates to the displayed content, such as the display refresh rate.

To maintain tracking accuracy under various conditions, the system can adapt. If the displayed content is too dark to create a clear reflection, the device can modulate a light source, such as by adding subtle patterns to the display or activating a backup infrared light. For augmented reality devices, if bright light from the physical environment interferes with the reflection, the device can modulate this external light, for example, by increasing the opacity of the display. This approach allows for robust and efficient eye tracking by leveraging the existing display and an event-based camera.

In some aspects, the techniques described herein relate to a method including: displaying content on an extended reality device; capturing, by a camera, a reflection from an eye of a user, the camera configured to identify changes to pixels in the reflection asynchronously; and detecting a movement of the eye based on a change to at least one pixel detected in the reflection.

In some aspects, the techniques described herein relate to a computing system including: at least one processor; a computer-readable storage medium operatively coupled to the at least one processor; and program instructions stored on the computer-readable storage medium that, when executed by the at least one processor, direct the computing system to perform a method, the method including: displaying content on an extended reality device; capturing, by a camera, a reflection from an eye of a user, the camera configured to identify changes to pixels in the reflection asynchronously; and detecting a movement of the eye based on a change to at least one pixel detected in the reflection.

In some aspects, the techniques described herein relate to a computer-readable storage medium having program instructions stored thereon that, when executed by at least one processor, direct the at least one processor to perform a method, the method including: displaying content on an extended reality device; capturing, by a camera, a reflection from an eye of a user, the camera configured to identify changes to pixels in the reflection asynchronously; and detecting a movement of the eye based on a change to at least one pixel detected in the reflection.

The accompanying drawings and the description below outline the details of one or more implementations. Other features will be apparent from the description, drawings, and claims.

### BRIEF DESCRIPTION OF THE DRAWINGS

FIG. 1 illustrates an example system for capturing reflections using a camera according to an implementation.

FIG. 2 illustrates a method of operating an XR device to monitor eye movement and gaze according to an implementation.

FIG. 3A illustrates an operational scenario of identifying eye movement according to an implementation.

FIG. 3B illustrates an operational scenario of identifying eye movement according to an implementation.

FIG. 4 illustrates an operational scenario of modulating a light source according to an implementation.

FIG. 5 illustrates an operational scenario of modulating a light source according to an implementation.

FIG. 6 illustrates an operational scenario of modulating light from a physical environment according to an implementation.

FIG. 7 illustrates a computing system to monitor eye movement using a camera according to an implementation.

### DETAILED DESCRIPTION

The concepts described herein relate to a method for tracking eye movement in an extended reality (XR) device that uses fewer resources. Many current eye-tracking systems rely on dedicated infrared (IR) light sources and cameras to track a user's gaze. This approach can be complex and consume a significant amount of power, potentially shortening the battery life of a portable XR device. The invention described here provides a more efficient solution by using the light already being generated by the device display to illuminate an eye of the user. A special type of camera, called a neuromorphic or event camera, can capture the reflection of the displayed content from the eye. This camera is designed to detect changes in light on a pixel-by-pixel basis, reducing the amount of data to be processed and lowering power consumption.

For example, a user may be looking at a specific icon shown on the XR device display. The neuromorphic camera can capture the reflection of that icon on the surface of the eye. When the user moves the eye to look at something else, the position of that reflection changes. The system can detect this change and interpret the change as eye movement. Because the system recognizes what content is being displayed and when the content changes, the system can distinguish between a change in the reflection caused by the eye moving and a change caused by the on-screen content being updated. This allows the device to accurately determine the direction of the user gaze in a power-efficient manner.

In some implementations, an XR device can include a display system, including an optical assembly, a processing system, and one or more sensors. An XR device is a wearable apparatus, such as a headset or glasses, designed to merge digital content with a user's perception of the physical world. Content is displayed to a user via the display system, which may comprise technologies like micro-OLED or Liquid Crystal Display (LCD) panels that generate images. These images are then directed toward the eyes of the user through the optical assembly, which can include a set of lenses, waveguides, or projection systems. In a virtual reality (VR) implementation, this assembly fully occludes the physical environment, immersing the user in a computer-generated world. In an augmented reality (AR) or mixed reality (MR) implementation, the optical assembly may be transparent or semi-transparent (an optical see-through system) or may use external cameras to capture and re-display the physical environment with digital overlays (a video see-through system).

The processing system can be configured to execute program instructions that render the visual content and manage the various device functions. To facilitate the eye-tracking method described herein, the sensor suite can include at least one neuromorphic (i.e., event-based) camera positioned to view the eye of the user. A neuromorphic camera, also known as an event camera or a dynamic vision sensor, operates fundamentally differently from a traditional camera that captures full frames of image data at a fixed rate. Instead of capturing entire images at set intervals, each pixel in a neuromorphic camera operates independently and asynchronously. A pixel generates an “event” when it detects a change in the intensity of light that crosses a certain threshold.

This event-driven approach means the camera does not produce a continuous sequence of full image frames. Instead, the camera outputs a sparse stream of data that captures changes in the visual scene. This method can significantly reduce the amount of redundant data that needs to be processed, leading to lower power consumption and very low latency. Because the camera is reporting changes, the camera is particularly well-suited for tracking high-speed motion, such as the subtle and rapid movements of a reflection on the surface of an eye.

In at least one implementation, a wearable XR device can be configured to display content. This content can include various virtual and augmented elements, such as interactive user interfaces, three-dimensional visuals, holograms, or other digital information projected into the field of view of a user. For example, an application may display a user interface comprising several interactive icons. The light emitted from the display to form these icons can illuminate the eye of the user, creating a reflection of the icons on the surface of the eye.

The XR device can further be configured to capture, using a camera (e.g., a neuromorphic or event camera), a reflection from an eye of a user, the camera configured to asynchronously identify changes to pixels in the reflection. Each pixel sensor in the neuromorphic camera operates as an independent and asynchronous logarithmic detector. A pixel will generate an output signal, referred to as an event, when the intensity of light the pixel perceives changes by a certain threshold amount. An event is a data packet that can include the pixel's location coordinates, a timestamp indicating when the change occurred, and the polarity of the change (i.e., an increase or decrease in brightness). Consequently, the camera does not produce a continuous stream of full-image frames but rather a sparse stream of event data that represents the dynamic parts of the scene. As the reflection of the displayed content shifts across the cornea of the eye, it causes a sequence of brightness changes that are captured as a spatiotemporal pattern of events by the camera.

The processing system can then analyze this stream of events to detect eye movement. To accomplish this, the system can distinguish between changes in the reflection caused by the eye moving and those caused by the displayed content being updated. Because the system controls the content being rendered, the device can determine the expected pattern of the reflection and the timing of any changes, such as the display's refresh rate. By comparing the incoming event data against the known timing of content updates, the system can filter out events associated with the display refresh. Any remaining clusters of events that do not correlate with a change in the displayed content can be attributed to the movement of the eye, allowing the system to accurately calculate the user's point of gaze in a computationally and power-efficient manner.

In some implementations, the XR device can be configured to operate in different modes to ensure reliable eye tracking under various lighting conditions. For scenes with sufficient brightness, a mode of operation can rely on the light emitted from the displayed content. In this mode, the processing system can pre-calculate an expected reflection pattern based on the content being rendered. The neuromorphic camera captures the actual glint, which is the small, bright reflection of the display on the cornea of an eye. This specular reflection appears as a high-contrast point of light on the corneal surface. The system then compares the captured event stream with the expected pattern. By filtering out changes corresponding to the display's known refresh rate, the system can isolate pixel changes attributable to eye movement, thereby determining the point of gaze.

For example, if a user is looking at a bright icon, its reflection forms a stable glint on the cornea, which is captured by a specific cluster of pixels on the camera. When the user shifts their gaze to a different icon, the eye rotates, causing this glint to move across the corneal surface. This movement generates a distinct spatiotemporal pattern of events. The pixels that previously detected the glint report a decrease in brightness, while a new cluster of pixels at the glint's new position reports an increase in brightness. The processing system can analyze the vector of this change from the old pixel cluster to the new one to calculate the precise direction and magnitude of the eye movement, thereby updating the user's point of gaze.

As an alternative example, a user's eye may remain stationary while looking at an animated loading icon. As the icon pulsates or spins, the light it emits changes, which in turn alters the shape and intensity of its reflection on the cornea. The neuromorphic camera captures these changes as a continuous stream of events. However, because the processing system is aware of the animation sequence being displayed, it can predict the exact pattern of these reflection changes. The system can correlate the incoming event data with the known timing of the display update. Since the detected changes match the expected pattern generated by the content itself, the system correctly concludes that the eye has not moved and filters out these events, preventing a false update to the point of gaze.

In some examples, a second operational mode can be used when the displayed content is too dark or sparse to generate a clear, trackable reflection, such as in a dark virtual environment or when viewing a small object on a black background. In this low-light mode, the system can determine that the brightness of the content has fallen below a certain threshold and can implement a fallback mechanism. The term “brightness of the content,” as used herein, refers to a quantifiable measure of the light emitted from the display, such as an average luminance of the rendered pixels. The threshold can be based on the minimum intensity required to produce a reflection with sufficient contrast for the camera to reliably monitor the necessary reflections.

In some examples, a mechanism can involve modulating a light source. As used herein, the term “modulating a light source” refers to actively altering the light output from a source, such as the device display or a dedicated emitter, for the purpose of generating a consistent and high-contrast glint on the cornea of an eye.

This can be achieved by updating the content with subtle, persistent user interface elements, such as faint dots or patterns in the periphery of the display (i.e., referred to as content elements), which are designed to create stable glints without distracting a user. A content element, as used herein, is a visual component rendered by the display system not as part of the primary user experience, but specifically to serve as a controlled illumination source for eye tracking. Examples of such elements can include a small, high-contrast dot in each corner of the display, a thin, faintly illuminated border around the field of view, or a subtle, high-frequency checkerboard pattern overlaid in dark regions of the scene. These elements are strategically designed to be minimally perceptible to the user while generating a consistent, high-contrast glint on the cornea.

Alternatively, the device can activate dedicated backup light sources, such as infrared (IR) LEDs, to illuminate an eye until the primary content is bright enough to resume its function as the illumination source. The technical effect of this modulation is the creation of a stable, high-contrast glint on the eye that is independent of the displayed content. This ensures the neuromorphic camera can continue to generate a reliable stream of event data for tracking, allowing the system to maintain accurate gaze detection even in low-luminance conditions where a reflection from the primary content would be insufficient.

For AR or mixed reality devices that use see-through optics, another mode may be implemented to address interference from ambient light in the physical environment. A large quantity of external light can overwhelm the faint reflection of the display, making it difficult for the camera to isolate the correct glint. To mitigate this, the device can modulate the light originating from the physical environment. This can involve dynamically increasing the opacity of the display system to dim or partially block the incoming external light. In another approach, the device can modulate the display's backlight at a specific frequency, allowing the event camera to be tuned to decode and exclusively capture reflections corresponding to that frequency, effectively filtering out the noise from ambient light sources.

By employing these adaptive modes, the XR device can maintain accurate and power-efficient eye tracking across a wide range of use cases and environments. The system can dynamically switch between using the display content, augmenting the display with tracking elements, activating backup IR emitters, or managing external light. This versatility ensures that the gaze detection system remains robust whether a user is in a fully immersive VR experience or an AR application that blends with a brightly lit physical world, all while optimizing for low power consumption and minimal processing overhead.

In some implementations, the device can be configured to determine an expected reflection of the content displayed to a user. Because the processing system renders visual information, the processing system can have precise knowledge of the shape, brightness, and timing of the elements shown on the display. Using this data, the system can pre-calculate a model of the reflection that this content is expected to create on the corneal surface of a stationary eye. This model, or expected reflection, accounts for dynamic changes in the content, such as animations, as well as the display's own refresh rate.

When the neuromorphic camera captures the actual reflection, the processing system can compare the incoming stream of events against this expected reflection pattern. If a user eye remains stationary while the content on the screen changes, the events generated by the camera will correlate directly with the pre-calculated changes. By matching the captured reflection data to the expected pattern, the system can confirm that the eye has not moved and can filter out events caused by content updates. This allows the system to isolate those changes that result from the physical movement of the eye, providing an accurate and reliable basis for gaze detection.

In some implementations, the device can be configured to filter changes that are associated with updates on the display. This filtering process is based on the system's ability to correlate the incoming event stream with known patterns of change originating from the display itself. For example, if a user maintains a fixed gaze on an animated icon, the icon's changing light will cause the reflection on the cornea to change in a predictable sequence. The neuromorphic camera captures these changes, but because this captured pattern matches the expected reflection generated by the system's knowledge of the animation, the system can correctly attribute the pixel activity to the dynamic content and filter out these events, preventing a false update to the point of gaze.

Another filtering mechanism can be based on the display's refresh rate. A display operates at a fixed frequency, such as 90 Hz, which causes a periodic, global update to the reflection that is captured by the camera as a synchronized burst of pixel activity. Because the processing system is aware of this refresh rate, it can anticipate this predictable pattern and filter it from the data stream. By subtracting these known, content-driven changes, the system can isolate the remaining asynchronous event patterns that are characteristic of the glint moving across the cornea due to the physical rotation of the eye.

The technical effect of the methods and processes described herein is a significant reduction in both power consumption and component complexity compared to traditional eye-tracking systems. By using the light already generated by the display as the primary illumination source, the XR device can eliminate the need for dedicated infrared (IR) light emitters. This directly saves power that would otherwise be consumed by these components. Further power savings are achieved by the neuromorphic camera, which generates a sparse data stream, reducing the computational load on the processing system compared to processing continuous full-frame images from a traditional camera.

This reduction in dedicated hardware also leads to space savings within the device. Eliminating IR emitters and their associated circuitry can allow for a more compact and lightweight headset design, which improves user comfort. Alternatively, the freed-up internal volume can be used for other components, such as a larger battery, to further extend the device's operational time. The overall technical result is a more efficient, streamlined, and power-conscious eye-tracking system integrated directly with the display and sensing capabilities of the XR device.

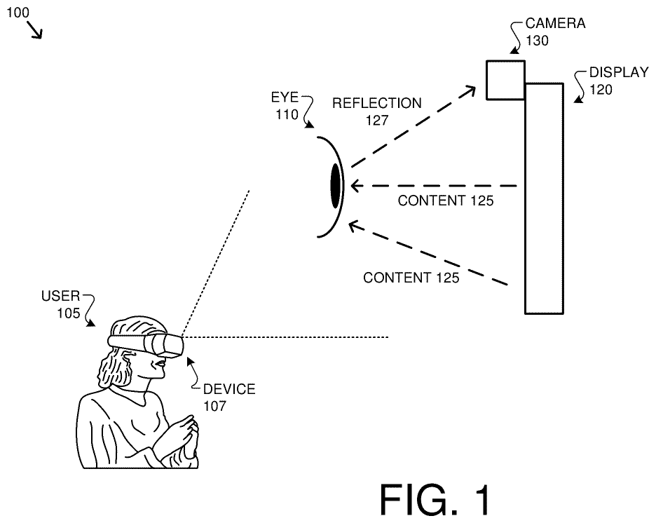

FIG. 1 illustrates an example system 100 for capturing reflections using a camera according to an implementation. System 100 includes user 105 with eye 110. System 100 further includes XR device 107 with display 120 and camera 130. Camera 130 can be representative of a neuromorphic camera or event camera in some examples. Display 120 provides content 125 as part of XR device 107, and camera 130 receives reflection 127 off eye 110.

In system 100, the XR device 107 can be worn by user 105, where the display 120 provides the content 125. Light from this content illuminates eye 110, which in turn produces the reflection 127 on the surface of the eye. The camera 130, which can be a neuromorphic camera, is positioned to capture this reflection. When user 105 moves eye 110, the position of reflection 127 shifts across the corneal surface. The camera 130 asynchronously detects this movement as a series of pixel changes. A processing system of XR device 107 (not shown) can then analyze these changes, distinguish them from changes caused by updates to the content 125, and thereby determine the gaze direction of user 105 in a power-efficient manner.

In some implementations, display 120 can be configured to present content 125 to user 105 as part of the visual experience provided by XR device 107. The content 125 can include a wide range of digital information, such as interactive user interfaces, three-dimensional visuals, holograms, or other virtual and augmented elements that are projected into the field of view of user 105. The display 120 itself may utilize various technologies, such as micro-OLED or Liquid Crystal Display (LCD) panels, to generate the images that form the content. These images are then directed toward eye 110 of user 105 through an optical assembly, which can consist of a configuration of lenses, waveguides, or projection systems. The specific implementation of this assembly can vary; for a virtual reality (VR) device, the optical assembly typically occludes the physical environment to fully immerse the user, while for an augmented reality (AR) or mixed reality (MR) device, the display may be an optical see-through system that is transparent or a video see-through system that merges digital overlays with a view of the physical world.

The camera 130 can be configured to capture the reflection 127 from the surface of eye 110. In some implementations, camera 130 is a neuromorphic camera, also known as an event camera, which operates differently from a traditional frame-based camera. Instead of capturing a sequence of full images at a fixed rate, each pixel sensor within camera 130 can function independently and asynchronously. A pixel sensor is configured to generate an output signal, or “event,” when it detects a change in light intensity that exceeds a predefined threshold. This event-driven functionality means camera 130 produces a sparse stream of data that represents the dynamic elements within its field of view, such as the movement of reflection 127.

A processing system can use the event data from camera 130 to determine movement of eye 110. The reflection 127, often referred to as a glint, is a specular reflection of the light from display 120 on the cornea, which is the curved outer surface of eye 110. When a user rotates eye 110 to shift their gaze, the orientation of this curved surface changes relative to the fixed positions of display 120 and camera 130. Consequently, the angle of reflection changes, causing the glint to move across the corneal surface. This movement of the glint results in a spatiotemporal pattern of brightness changes detected by camera 130. Specifically, pixels that previously detected the glint report a decrease in brightness, while a new set of pixels at the glint's new location reports an increase. The processing system can analyze this pattern of events, distinguish it from changes caused by updates to the content 125, and calculate a vector of movement. This vector can be used to determine the precise direction and magnitude of the eye's movement, thereby identifying the user's point of gaze.

The processing system of XR device 107 can effectively differentiate between changes in reflection 127 caused by updates to content 125 and those caused by the movement of eye 110. Because the system is provided with information about the rendered content, XR device 107 can generate an expected reflection pattern and predict how that pattern will change over time due to animations or display refresh cycles. For instance, if user 105 keeps eye 110 stationary while viewing an animated icon on display 120, the reflection 127 will change in sync with the animation. The camera 130 will capture these changes, but the processing system will correlate the resulting event data with the known timing of the animation. Since the detected changes match the expected pattern for the content update, the system correctly identifies that the eye has not moved. Conversely, if user 105 shifts their gaze from one static object to another, eye 110 rotates. This rotation causes the glint to move, generating a pattern of pixel changes that does not correspond to any update in the static content 125. By identifying this uncorrelated change, the system can attribute the changes to the movement of eye 110 and accurately update the user's point of gaze.

The system can determine the gaze vector by analyzing the spatiotemporal pattern of pixel events generated by camera 130. When the eye of user 105 rotates, the glint shifts across the corneal surface, causing a cluster of pixels at the glint's original location to detect a decrease in brightness, while a new cluster at its destination detects an increase. The processing system can identify these corresponding “off” and “on” events and calculate a movement vector from the geometric center of the first cluster to the second. This vector's direction and magnitude directly correlate to the angular rotation of the eye. To translate this movement vector into a precise gaze point on the display, XR device 107 can rely on a geometric model that accounts for the known positions of the display, the camera, and the general anatomy of the human eye. In some implementations, to achieve higher accuracy and account for individual variations in corneal curvature or eye position, the system can employ a user-specific calibration routine. During this calibration, the user is prompted to look at a series of predetermined points on the screen. The system records the unique pixel-change vectors associated with each gaze shift, creating a personalized map that accurately translates the observed glint movements into the final gaze vector. This calibration process serves as a form of on-device training, refining the geometric model for that specific user.

In some implementations, the XR device 107 can be configured to adapt to various lighting conditions to maintain tracking accuracy. For example, in situations where the content 125 on display 120 is too dark, such as in a dimly lit virtual environment or when viewing a small, isolated object on a black background, the resulting reflection 127 may be too faint or sparse to provide a reliable glint for camera 130 to track. Conversely, if the content 125 is uniformly bright, such as a completely white screen or a scene depicting a snowstorm, the reflection may become a large, washed-out area that lacks the distinct, high-contrast features needed for the neuromorphic camera to detect discrete changes.

To overcome these issues, XR device 107 can implement several adaptive strategies. In low-light conditions, the device can enter a fallback mode where it modulates a light source to ensure a trackable glint is present. This can be achieved by updating the content 125 to include subtle, persistent user interface elements, such as faint patterns or dots in the periphery of the display, that are bright enough to create a stable reflection without distracting a user. As another alternative, the device can activate dedicated backup light sources, such as infrared (IR) LEDs, to illuminate eye 110 until the primary content becomes bright enough to resume its role as the illumination source. In excessively bright scenes, the system can similarly modulate the display by introducing subtle, high-frequency contrast patterns that generate a consistent stream of events for camera 130.

Furthermore, for AR or MR devices with see-through optics, the system can account for conditions where the physical environment is excessively bright. A large amount of ambient light entering the device can overwhelm the comparatively faint reflection 127 from display 120, making it difficult for camera 130 to isolate the correct glint. To mitigate this interference, XR device 107 can be configured to modulate the light originating from the physical environment. This may involve dynamically increasing the opacity of the display system to dim or partially block the incoming external light. In another implementation, the device can modulate the backlight of display 120 at a specific, known frequency. The processing system can then instruct camera 130 to filter the incoming event data and exclusively track reflections that correspond to that frequency, effectively isolating the display glint from the noise of external light sources.

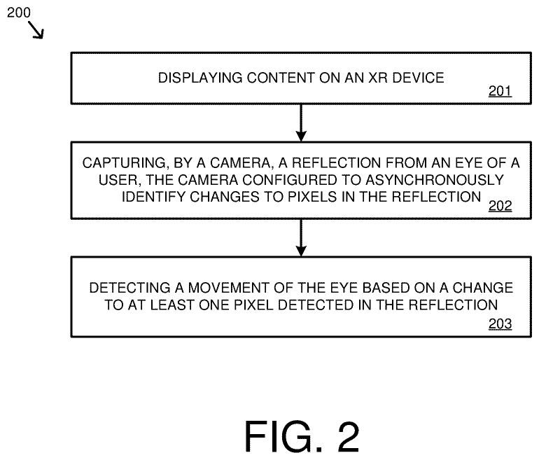

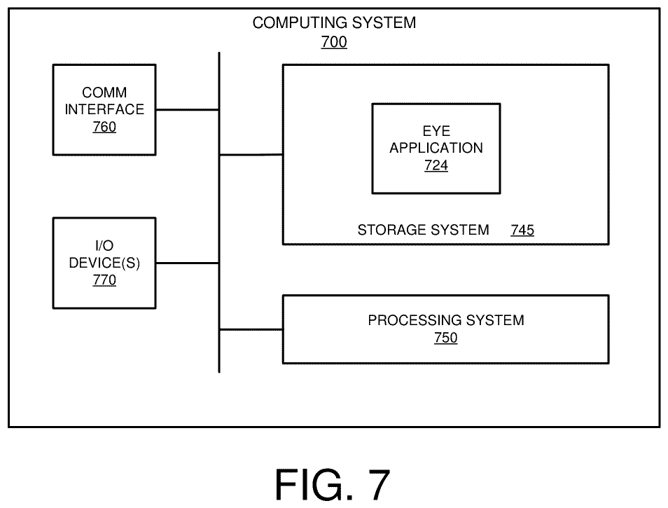

FIG. 2 illustrates method 200 of operating an XR device to monitor eye movement and gaze according to an implementation. Method 200 can be implemented by an XR device, such as XR device 107 in FIG. 1 or computing system 700 of FIG. 7.

Method 200 includes displaying content on an XR device at step 201. The content can include a wide variety of virtual and augmented elements, such as interactive user interfaces, three-dimensional visuals, holograms, or other digital information that is projected into the field of view of a user. These elements combine to create the visual experience for the user, blending digital information with the user's perception of the world.

The content is generated by a display system, which may use technologies like micro-OLED or LCD panels to create images. These images are then directed toward an eye of a user through an optical assembly, which can include a configuration of lenses, waveguides, or projection systems. For a virtual reality (VR) device, this assembly can be configured to fully occlude the physical environment to immerse the user. For an AR or MR device, the display can be an optical see-through system that is transparent or a video see-through system that merges digital overlays with a view of the physical world captured by external cameras.

Method 200 further includes capturing, by a camera, a reflection from an eye of a user, the camera configured to asynchronously identify changes to pixels in the reflection at step 202. The camera can be a neuromorphic or event camera, where each pixel functions as an independent, asynchronous sensor. Unlike a traditional camera that captures entire frames of image data at a fixed rate, a pixel in a neuromorphic camera generates an output signal, or an “event,” when it perceives a change in light intensity that crosses a specific threshold. This event is a small data packet that typically includes the pixel's coordinates, a high-resolution timestamp, and the polarity of the change (i.e., whether the light intensity increased or decreased). As a result, the camera does not produce a sequence of redundant, full-frame images. Instead, it outputs a sparse, continuous stream of data that exclusively represents the dynamic aspects of the scene being viewed, such as the shifting patterns of a reflection on the corneal surface of an eye.

For example, the content displayed on the XR device has a specific refresh rate, such as 90 Hz, meaning the entire image is updated every 11.1 milliseconds. This periodic update causes a global change in the reflection from the eye, which the neuromorphic camera captures as a large, simultaneous burst of events from all pixels detecting the reflection. Because the camera's timestamp resolution is much higher than the display's refresh interval, these predictable, synchronized event bursts can be identified and filtered out by a processing system. Any clusters of pixel events that occur between these refresh cycles, which do not correlate with known animations or changes in the displayed content, can therefore be attributed to other sources of motion. This allows the system to isolate changes caused by the physical movement of the eye from the background noise of the display's own operation.

Method 200 further includes detecting a movement of the eye based on a change to at least one pixel detected in the reflection at step 203. The processing system can detect this movement by analyzing the stream of events and distinguishing pixel changes caused by the eye's physical rotation from those caused by updates to the displayed content. The reflection of the display on the cornea, the transparent outer layer of the eye, creates a small, bright point of light often referred to as a glint. Because the cornea is a curved surface, the rotation of the eye changes the angle of this surface relative to the fixed positions of the display and the camera. Consequently, this glint moves across the corneal surface when a user shifts their gaze. This movement generates a characteristic spatiotemporal pattern of events that the neuromorphic camera captures. Specifically, the cluster of pixels that previously detected the glint will report a decrease in brightness (generating “off” events), while a new cluster of pixels at the glint's new position will report an increase in brightness (generating “on” events).

By analyzing this pattern, the processing system can calculate a movement vector that represents the direction and magnitude of the eye's rotation. The system can identify the geometric center of the cluster of “off” events and the corresponding center of the “on” events; the vector is then calculated between these two points. This vector can be translated into a precise gaze point on the display using a geometric model that accounts for the known positions of the display, the camera, and the anatomical structure of the human eye. To improve accuracy and account for individual variations like corneal curvature, the system can employ a user-specific calibration process. During calibration, the user can be prompted to look at a series of known points on the screen, allowing the system to record the unique pixel-change vectors associated with each gaze shift and create a personalized map that accurately translates glint movement into the final gaze vector.

For example, a user wearing the XR device may be looking at a static “start” button displayed on the left side of a user interface. The light from this button creates a stable glint on the cornea, which is captured by a specific cluster of pixels in the neuromorphic camera. The user then decides to look at an “options” button located on the right side of the interface. This action causes the eye to rotate physically in its socket.

As the eye rotates, the glint moves across the corneal surface. The neuromorphic camera detects this movement as a distinct spatiotemporal pattern of events. The original cluster of pixels that detected the glint reports a decrease in brightness, generating “off” events, while a new cluster of pixels to the right reports an increase in brightness, generating “on” events. Because the processing system knows that the displayed buttons are static and have not changed, it correctly attributes this pattern of pixel changes to the physical movement of the eye. By calculating the vector from the location of the “off” events to the location of the “on” events, the system can determine that the user's gaze has shifted to the “options” button.

In some implementations, the device can be configured to update or modulate the light available for reflection. This modification can occur when the light from the display exceeds a threshold, the light from the display is below a threshold, or the light from the physical environment satisfies at least one criterion. For example, the system can determine a brightness of the content displayed to a user. If the brightness satisfies a criterion, such as falling below a predetermined threshold, the system can modulate at least one light source to ensure a reliable glint is produced. This modulation can be performed by updating the content with at least one new content element, such as adding faint, persistent dots or patterns in the periphery of the display that are bright enough to create a stable reflection without distracting a user. In another implementation, if the content is too dark to provide a useful reflection, the device can emit light from at least one dedicated infrared light source, such as an IR LED, to illuminate the eye. This serves as a fallback mechanism, creating a high-contrast glint for the camera to track until the primary content is bright enough to resume its function as the illumination source.

The term “at least one criterion,” as used herein, refers to a predefined condition or a set of rules that the processing system uses to evaluate whether the current lighting conditions are adequate for reliable eye tracking. A criterion can be based on a variety of measurable parameters, such as a luminance value of the displayed content falling below a minimum threshold, a lack of sufficient contrast in the content, or a quantity of ambient light exceeding an interference threshold. When a measured parameter satisfies a criterion, it can trigger the system to enter an adaptive mode to modulate a light source, thereby ensuring a stable and trackable glint is maintained on the corneal surface.

In other implementations, particularly for AR or MR devices with see-through optics, the system can determine that a quantity of light from the physical environment satisfies at least one criterion, such as being bright enough to interfere with the camera's ability to detect the display reflection. In response, the device can modulate the light from the physical environment to mitigate this interference. This can be accomplished by dynamically increasing the opacity of the display system, which dims or partially blocks the incoming external light. As another approach, the device can modulate the display's backlight at a specific, known frequency. The processing system can then filter the camera's event stream to exclusively track reflections that correspond to that frequency, effectively isolating the display glint from the noise of ambient light sources.

The technical effect of this method is a significant reduction in both power consumption and hardware complexity compared to traditional eye-tracking systems. By using the display's own light as the illumination source, the XR device can eliminate the need for power-hungry, dedicated infrared (IR) emitters. Additional power savings come from using a neuromorphic camera, which generates a sparse data stream requiring far less processing than the continuous video frames from a standard camera. This streamlined approach also saves physical space within the headset by removing components, which can lead to a lighter, more comfortable design or allow for the inclusion of a larger battery to extend the device's operating time.

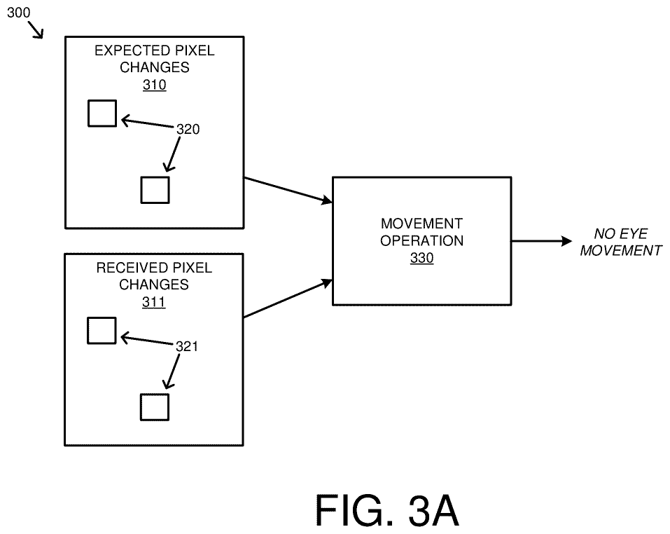

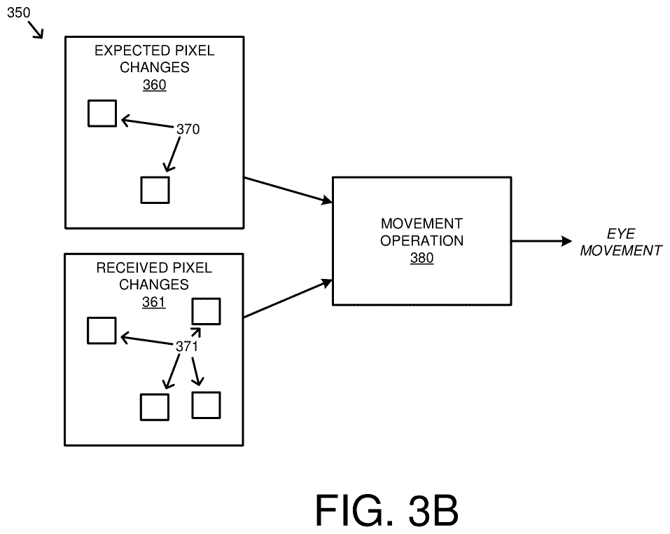

FIG. 3A illustrates an operational scenario 300 of identifying eye movement according to an implementation. Operational scenario 300 includes expected pixel changes 310 with pixels 320, received pixel changes 311 with pixels 321, and eye movement operation 330.

In operational scenario 300, an XR device can be configured to predict and filter pixel changes to isolate eye movement. The processing system has access to all information about the content being rendered, including the luminance, geometry, and timing of every visual element. Using this data, the system generates the expected pixel changes 310, which is a pre-calculated model of how the reflection should appear and change over time if the eye of a user remains stationary. This model accounts for dynamic content, such as animations, as well as the display's own refresh rate. For example, on a display with a 90 Hz refresh rate, the system anticipates a global change in the reflection every 11.1 milliseconds and incorporates this predictable, synchronized pattern into the expected pixel changes 310.

The neuromorphic camera provides the processing system with the received pixel changes 311. This is not a series of full image frames but a sparse, asynchronous stream of data packets called “events.” Each event can contain the coordinates of a pixel that detected a change, a high-resolution timestamp, and the polarity of the change (an increase or decrease in brightness). In the eye movement operation 330, the processing system performs a differential analysis by comparing the incoming stream of received pixel changes 311 against the pre-calculated expected pixel changes 310.

Here, the received pixel changes 311 satisfy similarity criteria in association with expected pixel changes 310. When the received pixel changes 311 satisfy similarity criteria with the expected pixel changes 310, it indicates that the changes detected by the neuromorphic camera are consistent with the pre-calculated model of how the reflection should change due to updates in the displayed content alone. This correlation suggests that no independent eye movement has occurred. The processing system reaches this conclusion by comparing the spatiotemporal pattern of the incoming event stream against the expected pattern, which accounts for factors like the display's refresh rate or known animations. For example, if a user maintains a fixed gaze on an animated loading icon, the icon's pulsating light will cause the reflection on the cornea to change in a predictable sequence. The neuromorphic camera captures these changes as the received pixel changes 311. Since this captured pattern matches the expected pixel changes 310 generated by the system's knowledge of the animation, the system correctly attributes the pixel activity to the dynamic content. As a result, these events are filtered out, and the system concludes that the eye has remained stationary, thus preventing a false detection of a gaze shift.

The technical effect of this filtering process is the prevention of false positive gaze shifts. By disregarding event patterns that correlate with known content updates, the system ensures that changes originating from the physical rotation of the eye are used to calculate the gaze vector. This significantly enhances the accuracy and stability of the eye-tracking system, making it robust even when a user is viewing dynamic or rapidly changing visual content.

FIG. 3B illustrates an operational scenario 350 of identifying eye movement according to an implementation. Operational scenario 350 includes expected pixel changes 360 with pixels 370, received pixel changes 361 with pixels 371, and eye movement operation 380.

In operational scenario 350, the XR device can be configured to differentiate eye movement from other visual updates by predicting and filtering pixel activity. The processing system leverages its awareness of the rendered content, including the brightness, geometry, and timing of each visual element. With this information, the system can generate the expected pixel changes 360, which represents a predictive template modeling how the reflection should appear and evolve over time, assuming the eye of a user remains stationary. This template accounts for dynamic factors such as animations and the display's refresh rate. For example, for a display operating at 90 Hz, the system can anticipate a global update to the reflection every 11.1 milliseconds and factor this predictable, synchronous pattern into the expected pixel changes 360.

The camera supplies the processing system with the received pixel changes 361. This input is not a sequence of full image frames, but an asynchronous flow of data packets known as “events.” An event can contain information such as the location of the pixel that detected a change, a high-precision timestamp, and the direction of the brightness shift (e.g., an increase or decrease). In the eye movement operation 380, the processing system conducts a comparative analysis, contrasting the incoming stream of received pixel changes 361 against the predictive template of expected pixel changes 360.

Here, received pixel changes 361 differentiate from expected pixel changes 360 by a threshold amount, indicating movement has occurred in association with the eye. When this discrepancy occurs, the processing system determines that the detected changes do not correlate with the pre-calculated model for content updates, such as the display's refresh rate or known animations. The system can therefore attribute this uncorrelated activity to the physical movement of the eye. As the eye rotates, the glint, which is the reflection of the display, moves across the curved surface of the cornea. This movement creates a distinct spatiotemporal pattern of events captured by the camera. The cluster of pixels that previously detected a glint can report a decrease in brightness, generating “off” events, while a new cluster of pixels at the glint's new position reports an increase in brightness, generating “on” events. The processing system can identify this pattern of “off” and “on” events, calculate a movement vector from the geometric center of the first cluster to the second, and use this vector to determine the precise direction and magnitude of the eye's rotation, thereby updating the user's point of gaze.

In some implementations, the device can filter changes associated with changes on the display. This filtering process is based on the system's ability to correlate the incoming event stream with known patterns of change originating from the display itself. For example, the display operates at a fixed refresh rate (e.g., 90 Hz), which causes a periodic, global update to the reflection that is captured by the camera. The processing system can anticipate this synchronized burst of pixel activity across the reflection and filter the activity from the data stream. By subtracting these predictable, content-driven changes, the system can isolate the remaining asynchronous event patterns that are characteristic of the glint moving across the cornea due to the physical rotation of the eye. Thus, while a portion of changed pixels can correspond to the change in display, other changes can correspond to the movement of the eye.

For example, a user may be looking at a static icon on the left side of the display. In this case, the expected pixel changes 360 would model a stable reflection with minimal activity. If the user then shifts their gaze to another static icon on the right, the eye physically rotates. The camera captures the received pixel changes 361, which show a distinct pattern of “off” events on the left and “on” events on the right that does not match the expected pattern. By detecting this significant deviation, the system correctly concludes that the eye has moved, calculates the vector of this change, and updates the gaze point to the new icon on the right.

The technical effect of this differential analysis, as illustrated in FIG. 3A and FIG. 3B, is a highly accurate and computationally efficient method for gaze detection. By comparing the actual event stream against a predictive model, the system can effectively isolate the spatiotemporal patterns generated by the physical rotation of the eye from the predictable background noise of display updates and content animations. As shown in FIG. 3A, when the received changes match the expected pattern, the system correctly identifies the eye as stationary, which prevents false gaze shifts caused by dynamic content. Conversely, as shown in FIG. 3B, when the received changes deviate from the expected pattern, the system can reliably attribute the discrepancy to eye movement and calculate a precise gaze vector. This process results in a robust eye-tracking system that maintains high fidelity even in visually complex environments. The overall technical result is a significant reduction in processing overhead and power consumption compared to traditional systems that must process full image frames, leading to a more efficient and responsive user experience in the XR device.

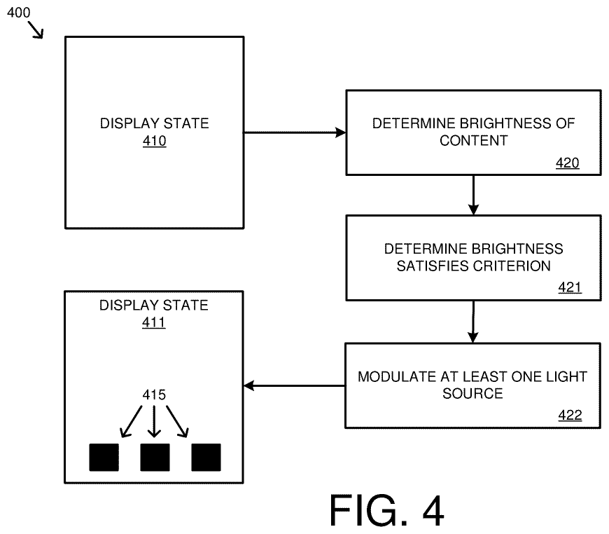

FIG. 4 illustrates an operational scenario 400 of modulating a light source according to an implementation. Operational scenario 400 includes display state 410, step 420, step 421, step 422, display state 411, and additional content 415. Operational scenario 400 can be performed by an XR device, such as XR device 107 from FIG. 1.

In operational scenario 400, an XR device provides display state 410. Display state 410 can represent the complete set of visual information being rendered on the display of the XR device at a specific point in time. This information can include displayed objects, such as user interface elements, virtual scenery, or augmented overlays, as well as their associated properties, such as brightness, color, and geometry. A display state can be technically defined as a comprehensive data snapshot that encapsulates pixel-level information and the timing of its presentation to a user, providing the system with a complete picture of the light being emitted toward an eye.

At step 420, the XR device determines a brightness of the content. This determination can be based on an analysis of the rendered content, such as the luminance values of the pixels making up the scene. In some implementations, this brightness can also be measured directly using one or more light sensors integrated into the device. At step 421, the XR device determines that the brightness satisfies at least one criterion and modulates the at least one light source based on satisfying the at least one criterion at step 422. For example, the criterion can be that the brightness of the displayed content falls below a predetermined threshold, which can occur in a dark virtual environment or when viewing a small object on a black background. In such a case, the reflection from the eye may be too faint or sparse to provide a reliable glint for the camera to track. To address this, the device can modulate the light source by updating the content on the display itself. This can be achieved by rendering subtle, persistent user interface elements, such as faint dots or patterns in the periphery of the display. These elements can be bright enough to create a stable, high-contrast reflection without distracting a user, ensuring the neuromorphic camera receives a consistent stream of events. In some examples, the system can also increase the overall brightness of one or more existing elements, such as icons, to provide the required reflections to do the eye tracking operations as described herein.

Conversely, the criterion can be that the content is too uniformly bright or lacks sufficient contrast, such as a completely white screen. This can result in a large, washed-out reflection that lacks the distinct features needed for the neuromorphic camera to detect discrete changes. In this scenario, the device can modulate the display by introducing subtle, high-frequency contrast patterns or by pulsing certain elements at a specific frequency. This action generates a consistent stream of “on” and “off” events from the reflection, even if the eye is stationary, which allows the system to maintain a lock on the glint and ensure tracking accuracy. The result of these modulations is display state 411, where the visual information has been altered to produce a more reliable reflection.

As demonstrated in display state 411, the XR system adds additional content 415 that can be used to illuminate the eye and increase reflection. This additional content 415 can take the form of subtle but persistent user interface elements, such as faint dots or geometric patterns, which are rendered in the periphery of the display to avoid distracting a user. The technical function of these elements is to serve as a controlled illumination source, generating a stable, high-contrast glint on the corneal surface that is independent of the primary visual scene. When the neuromorphic camera captures the reflection, the movement of this artificially generated glint creates a distinct spatiotemporal pattern of pixel events. Because these elements provide a bright point against a dark background, the resulting event stream is clear and sparse, enabling the processing system to reliably calculate the eye's movement vector with minimal computational overhead. This permits accurate gaze tracking even in low-light scenarios.

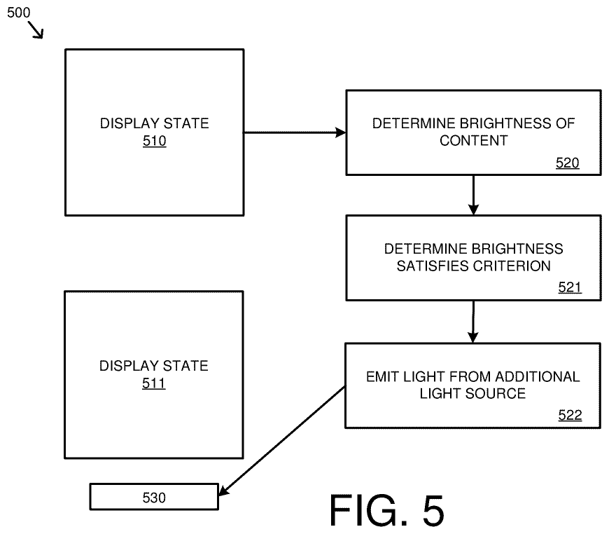

FIG. 5 illustrates an operational scenario 500 of modulating a light source according to an implementation. Operational scenario 500 includes display state 510, step 520, step 521, step 522, display state 511, and additional light source 530.

In operational scenario 500, an XR device provides display state 510. Display state 510 can represent the visual output of the XR device at a given time. This state encompasses rendered content, including interactive elements and virtual objects, along with their visual properties, such as luminance and color. As a comprehensive data snapshot, this state provides the system with a complete model of the light being directed toward an eye of a user.

At step 520, the XR device determines a brightness of the content. This determination can be based on an analysis of the rendered content, such as the luminance values of the pixels making up the scene. In some implementations, this brightness can also be measured directly using one or more light sensors integrated into the device. Once the brightness is determined, the XR device can determine that the brightness satisfies at least one criterion at step 521 and, based on satisfying the at least one criterion, emit light from at least one light source 530 at step 522 (i.e., modulate a light source). In some implementations, the light source can include an infrared LED, which serves as a supplemental illumination source.

For example, the criterion can be that the brightness of the content in display state 510 falls below a predetermined luminance threshold, which can occur in a dark virtual environment or when viewing a small object on a black background. In this scenario, the reflection from the eye may be too faint or sparse to provide a reliable glint for the camera to track. To address this, the system can activate the additional light source 530 as a fallback mechanism. The light source 530, which can be an infrared (IR) light-emitting diode (LED), produces light that is invisible to the human eye and therefore does not alter the user's perception of the displayed content. The result is display state 511, which appears identical to display state 510 from the user's perspective, but is now illuminated by the IR light. This light creates a stable, high-contrast glint on the corneal surface, ensuring that the neuromorphic camera can continue to generate a reliable stream of event data for tracking, thus maintaining accurate gaze detection even in low-light conditions. Once the light emitted from the display returns to a luminance threshold, the device can be configured to stop emitting light from light source 530.

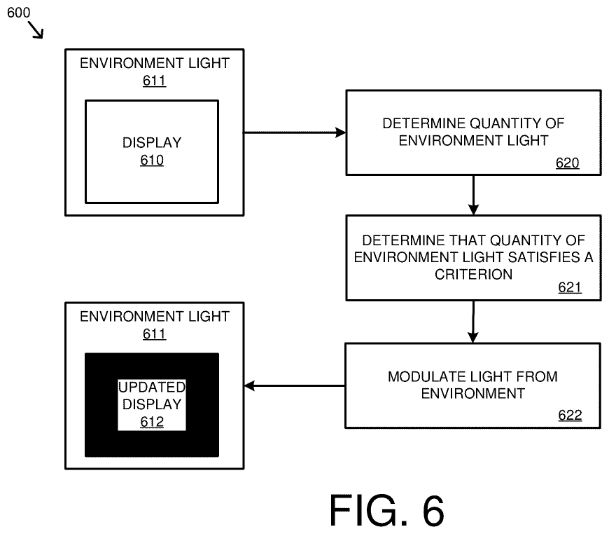

FIG. 6 illustrates an operational scenario 600 of modulating light from a physical environment according to an implementation. Operational scenario 600 includes display 610, environment light 611, and updated display 612. Operational scenario 600 further includes step 620, step 621, and step 622.

In operational scenario 600, an XR device, particularly an augmented or mixed reality device with see-through optics, can be configured to manage interference from the physical environment. As shown, environment light 611 from the physical world passes through display 610. A large quantity of this external light can overwhelm the comparatively faint reflection of the display on an eye, making it difficult for a camera to isolate the correct glint for tracking. At step 620, the XR device can determine a quantity of the environment light 611, for example, by using an integrated ambient light sensor. At step 621, the device can determine that this quantity satisfies at least one criterion, such as exceeding a brightness threshold that could interfere with reflection detection. Based on this determination, the device can modulate the light from the physical environment at step 622. This modulation can be accomplished by dynamically increasing the opacity of display 610, which functions to dim or partially block the incoming external light. This action results in an updated display 612 that allows the display's reflection to become more prominent and reliably trackable.

As used herein, the term “quantity of light from a physical environment” refers to a quantifiable measure of ambient illumination originating from outside the extended reality device and entering a user's field of view. This measure can be derived from sensor data, such as illuminance expressed in lux, and is used to assess potential interference with the eye-tracking system.

For example, a user wearing an AR device with a see-through display may be outdoors in bright sunlight. The environment light 611 from the sun can be so intense that it overwhelms the fainter reflection of the display on an eye of the user, making the glint difficult for the camera to isolate. An ambient light sensor within the device can determine that the quantity of external light satisfies a criterion, such as exceeding an interference threshold. In response, the processing system can modulate the incoming light by dynamically increasing the opacity of the display, which functions like a self-tinting lens. This results in the updated display 612, where the external brightness is reduced, allowing the glint to become the dominant reflection for the camera to track, thereby maintaining accurate gaze detection in a bright physical environment.

In some implementations, an XR device can be configured to analyze both the brightness of the displayed content and the brightness of the physical environment to intelligently modulate light sources for optimal eye tracking. The device can include sensors, such as an ambient light sensor, to measure the quantity of external light entering the see-through display. Additionally, the processing system can analyze the luminance values of the content being rendered on the display. Based on one or more criteria related to these brightness levels, the system can dynamically adjust light sources to ensure a clear, high-contrast glint is always available for the camera to track.

For example, a user wearing an AR device may be viewing a dark virtual object in a brightly lit office. The system would first determine that the brightness of the displayed content is below a threshold, making its reflection too faint for reliable tracking. At the same time, an ambient light sensor would determine that the external light from the office is above an interference threshold, which could overwhelm any faint glint. In response, the device can perform a dual modulation: it can increase the opacity of the display to dim the incoming environmental light, and it can simultaneously update the display content to include a subtle, bright pattern in the user's peripheral vision. The technical effect is the creation of a stable, high-contrast glint from the new pattern against a less intrusive background, allowing for accurate gaze detection under challenging mixed-lighting conditions.

FIG. 7 illustrates a computing system 700 to monitor eye movement using a camera according to an implementation. Computing system 700 is representative of any computing system or systems with which the various operational architectures, processes, scenarios, and sequences disclosed herein can be implemented to determine eye movement as described herein. Computing system 700 may represent a wearable computing device, such as an XR device or smart glasses. Computing system 700 can include multiple computing devices in some examples (e.g., a wearable device and a companion device, such as a smartphone or tablet). Computing system 700 includes storage system 745, processing system 750, communication interface 760, and input/output (I/O) device(s) 770. Processing system 750 is operatively linked to communication interface 760, I/O device(s) 770, and storage system 745. In some implementations, communication interface 760 and/or I/O device(s) 770 may be communicatively linked to storage system 745. Computing system 700 may further include other components, such as a battery and enclosure, that are not shown for clarity.

Communication interface 760 comprises components that communicate over communication links, such as network cards, ports, radio frequency, processing circuitry and software, or some other communication devices. Communication interface 760 may be configured to communicate over metallic, wireless, or optical links. Communication interface 760 may be configured to use Time Division Multiplex (TDM), Internet Protocol (IP), Ethernet, optical networking, wireless protocols, communication signaling, or some other communication format, including combinations thereof. Communication interface 760 may be configured to communicate with external devices, such as servers, user devices, or some other computing device.

I/O device(s) 770 may include computer peripherals that facilitate the interaction between the user and computing system 700. Examples of I/O device(s) 770 may include keyboards, mice, trackpads, monitors, displays, printers, cameras, microphones, external storage devices, and the like.

Processing system 750 comprises microprocessor circuitry (e.g., at least one processor) and other circuitry that retrieves and executes operating software from storage system 745. Storage system 745 may include volatile and nonvolatile, removable, and non-removable media implemented in any method or technology for information storage, such as computer-readable instructions, data structures, program modules, or other data. Storage system 745 may be implemented as a single storage device, but may also be implemented across multiple storage devices or sub-systems. Storage system 745 may comprise additional elements, such as a controller to read operating software from the storage systems. Examples of storage media (also referred to as computer-readable storage media) include random access memory, read-only memory, magnetic disks, optical disks, and flash memory, as well as any combination or variation thereof or any other type of storage media. In some implementations, the storage media may be non-transitory. In some instances, at least a portion of the storage media may be transitory. In no case is the storage media a propagated signal.

Processing system 750 is typically mounted on a circuit board that may hold the storage system. The operating software of storage system 745 comprises computer programs, firmware, or another form of machine-readable program instructions. The operating software of storage system 745 comprises eye application 724. The operating software on storage system 745 may include an operating system, utilities, drivers, network interfaces, applications, or other types of software. When read and executed by processing system 750, the operating software on storage system 745 directs computing system 700 to operate as described in the previously described Figures.

In at least one implementation, eye application 724 directs processing system 750 to perform a series of operations to provide power-efficient eye tracking. The processing system 750 can execute instructions to control one of the I/O device(s) 770, such as a display, to present visual content to a user. The light emitted from this content illuminates an eye of the user, creating a reflection on the corneal surface. Another of the I/O device(s) 770, a neuromorphic camera, is positioned to capture this reflection. This camera operates asynchronously, meaning each pixel sensor independently reports an event when it detects a change in light intensity, rather than capturing full image frames at a fixed rate.

The processing system 750 can then analyze the sparse stream of event data from the camera to identify eye movement. To distinguish changes in the reflection caused by eye rotation from changes caused by updates to the displayed content, the processing system 750 can leverage its knowledge of the rendered visuals. Because the system controls the content, the system can determine an expected reflection pattern, accounting for dynamic elements and the display's own refresh rate. The processing system 750 can compare the incoming event data from the camera against this pre-calculated model.

By filtering out event patterns that correlate with known content updates, such as the periodic burst of activity caused by a 90 Hz display refresh, the system can isolate the spatiotemporal patterns of pixel changes that are attributable to the physical movement of the eye. When a user shifts their gaze, the reflection moves across the cornea, generating a distinct sequence of “off” and “on” events that does not match the expected pattern for a stationary eye. The processing system 750 can detect this uncorrelated change and calculate a precise gaze vector based on the movement.

To ensure reliable tracking across various conditions, eye application 724 can direct the processing system 750 to operate in adaptive modes. The processing system 750 can determine the brightness of the displayed content. If the brightness falls below a specific criterion, indicating the content is too dark to produce a clear reflection, the system can modulate a light source. One method involves updating the content by adding subtle, persistent elements, such as faint dots in the periphery of the display, which are bright enough to create a stable glint without distracting a user.

As an alternative fallback for low-light scenarios, the processing system 750 can activate a dedicated backup light source, another of the I/O device(s) 770, such as at least one infrared (IR) light-emitting diode (LED). This IR light, invisible to the user, illuminates the eye to create a high-contrast glint for the neuromorphic camera to track, ensuring continuous operation until the primary content is bright enough to resume its function as the illumination source.

For AR or MR devices with see-through optics, the system can also manage interference from the external environment. The processing system 750 can use an I/O device, such as an ambient light sensor, to determine the quantity of light entering from the physical world. If the amount of this light satisfies a criterion, such as exceeding a threshold that could overwhelm the display's reflection, the system can modulate this external light. This can be achieved by instructing the display system, an example I/O device, to dynamically increase its opacity, thereby dimming the incoming environmental light and making the internal reflection more prominent and trackable.

Through these operations, computing system 700 provides a robust and versatile eye-tracking solution. By intelligently using the display as the primary light source, employing a power-efficient neuromorphic camera, and adaptively modulating internal and external light sources based on real-time conditions, the system can accurately detect eye movement with significantly reduced power consumption and hardware complexity compared to traditional eye-tracking methods.

Below are example clauses associated with the present disclosure. The described clauses should not be considered exhaustive.

Clause 1. A method comprising: displaying content on an extended reality device; capturing, by a camera, a reflection from an eye of a user, the camera configured to asynchronously identify changes to pixels in the reflection; and detecting a movement of the eye based on a change to at least one pixel detected in the reflection.

Clause 2. The method of clause 1 further comprising: determining a brightness of the content; and modulating at least one light source based on the brightness satisfying at least one criterion.

Clause 3. The method of clause 1 further comprising: determining a brightness of the content; and updating the content with at least one content element based on the brightness satisfying at least one criterion.

Clause 4. The method of clause 1 further comprising: determining that a quantity of light from a physical environment satisfies at least one criterion; and modulating the light from the physical environment in the extended reality device based on the quantity of the light satisfying the at least one criterion.

Clause 5. The method of clause 1 further comprising: determining an expected reflection based on the content; and comparing the expected reflection to the reflection to detect the change to the at least one pixel.

Clause 6. The method of clause 1 further comprising: determining a refresh rate for a display of the extended reality device; and filtering data from the camera based on the refresh rate.

Clause 7. The method of clause 1 further comprising: determining a brightness of the content; and emitting light from at least one infrared light source based on the brightness of the content satisfying at least one criterion.

Clause 8. A computing system comprising: at least one processor; a computer-readable storage medium operatively coupled to the at least one processor; and program instructions stored on the computer-readable storage medium that, when executed by the at least one processor, direct the computing system to perform a method, the method comprising: displaying content on an extended reality device; capturing, by a camera, a reflection from an eye of a user, the camera configured to asynchronously identify changes to pixels in the reflection; and detecting a movement of the eye based on a change to at least one pixel detected in the reflection.

Clause 9. The computing system of clause 8, wherein the method further comprises: determining a brightness of the content; and modulating at least one light source based on the brightness satisfying at least one criterion.

Clause 10. The computing system of clause 8, wherein the method further comprises: determining a brightness of the content; and updating the content with at least one content element based on the brightness satisfying at least one criterion.

Clause 11. The computing system of clause 9, wherein the method further comprises: determining that a quantity of light from a physical environment satisfies at least one criterion; and modulating the light from the physical environment in the extended reality device based on the quantity of the light satisfying the at least one criterion.

Clause 12. The computing system of clause 9, wherein the method further comprises: determining an expected reflection based on the content; and comparing the expected reflection to the reflection to detect the change to the at least one pixel.

Clause 13. The computing system of clause 9, wherein the method further comprises: determining a refresh rate for a display of the extended reality device; and filtering data from the camera based on the refresh rate.

Clause 14. The computing system of clause 9, wherein the method further comprises: determining a brightness of the content; and emitting light from at least one infrared light source based on the brightness of the content satisfying at least one criterion.

Clause 15. The computing system of clause 9, wherein the computing system further comprises the camera.

Clause 16. A computer-readable storage medium having program instructions stored thereon that, when executed by at least one processor, direct the at least one processor to perform a method, the method comprising: displaying content on an extended reality device; capturing, by a camera, a reflection from an eye of a user, the camera configured to asynchronously identify changes to pixels in the reflection; and detecting a movement of the eye based on a change to at least one pixel detected in the reflection.

Clause 17. The computer-readable storage medium of clause 16, wherein the method further comprises: determining a brightness of the content; and modulating at least one light source based on the brightness satisfying at least one criterion.

Clause 18. The computer-readable storage medium of clause 16, wherein the method further comprises: determining a brightness of the content; and updating the content with at least one content element based on the brightness satisfying at least one criterion.

Clause 19. The computer-readable storage medium of clause 16, wherein the method further comprises: determining that a quantity of light from a physical environment satisfies at least one criterion; and modulating the light from the physical environment in the extended reality device based on the quantity of the light satisfying the at least one criterion.

Clause 20. The computer-readable storage medium of clause 16, wherein the method further comprises: determining an expected reflection based on the content; and comparing the expected reflection to the reflection to detect the change to the at least one pixel.

In accordance with aspects of the disclosure, implementations of various techniques and methods described herein may be implemented in digital electronic circuitry, or in computer hardware, firmware, software, or in combinations of them. Implementations may be implemented as a computer program product (e.g., a computer program tangibly embodied in an information carrier, a machine-readable storage device, a computer-readable medium, a tangible computer-readable medium), for processing by, or to control the operation of, data processing apparatus (e.g., a programmable processor, a computer, or multiple computers). In some implementations, a tangible computer-readable storage medium may be configured to store instructions that, when executed, cause a processor to perform a process. A computer program, such as the computer program(s) described above, may be written in any form of programming language, including compiled or interpreted languages, and may be deployed in any form, including as a standalone program or as a module, component, subroutine, or other unit suitable for use in a computing environment. A computer program may be deployed to be processed on one computer or on multiple computers at one site or distributed across multiple sites and interconnected by a communication network.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the implementations. They have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

It will be understood that, in the foregoing description, when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application, if any, may be amended to recite exemplary relationships described in the specification or shown in the figures.

As used in this specification, a singular form may, unless definitively indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

What is claimed is:

1. A method comprising:
displaying content on an extended reality device;
capturing, by a camera, a reflection from an eye of a user, the camera configured to identify changes to pixels in the reflection asynchronously; and
detecting a movement of the eye based on a change to at least one pixel detected in the reflection.

2. The method of claim 1 further comprising:
determining a brightness of the content; and
modulating at least one light source based on the brightness satisfying at least one criterion.

3. The method of claim 1 further comprising:
determining a brightness of the content; and
updating the content with at least one content element based on the brightness satisfying at least one criterion.

4. The method of claim 1 further comprising:
determining that a quantity of light from a physical environment satisfies at least one criterion; and
modulating the light from the physical environment in the extended reality device based on the quantity of the light satisfying the at least one criterion.

5. The method of claim 1 further comprising:
determining an expected reflection based on the content; and
comparing the expected reflection to the reflection to detect the change to the at least one pixel.

6. The method of claim 1 further comprising:
determining a refresh rate for a display of the extended reality device; and
filtering data from the camera based on the refresh rate.

7. The method of claim 1 further comprising:
determining a brightness of the content; and
emitting light from at least one infrared light source based on the brightness of the content satisfying at least one criterion.

8. A computing system comprising:
at least one processor;
a computer-readable storage medium operatively coupled to the at least one processor; and
program instructions stored on the computer-readable storage medium that, when executed by the at least one processor, direct the computing system to perform a method, the method comprising:
displaying content on an extended reality device;
capturing, by a camera, a reflection from an eye of a user, the camera configured to identify changes to pixels in the reflection asynchronously; and
detecting a movement of the eye based on a change to at least one pixel detected in the reflection.

9. The computing system of claim 8, wherein the method further comprises:
determining a brightness of the content; and
modulating at least one light source based on the brightness satisfying at least one criterion.

10. The computing system of claim 8, wherein the method further comprises:
determining a brightness of the content; and
updating the content with at least one content element based on the brightness satisfying at least one criterion.

11. The computing system of claim 9, wherein the method further comprises:
determining that a quantity of light from a physical environment satisfies at least one criterion; and
modulating the light from the physical environment in the extended reality device based on the quantity of the light satisfying the at least one criterion.

12. The computing system of claim 9, wherein the method further comprises:
determining an expected reflection based on the content; and
comparing the expected reflection to the reflection to detect the change to the at least one pixel.

13. The computing system of claim 9, wherein the method further comprises:
determining a refresh rate for a display of the extended reality device; and
filtering data from the camera based on the refresh rate.

14. The computing system of claim 9, wherein the method further comprises:
determining a brightness of the content; and
emitting light from at least one infrared light source based on the brightness of the content satisfying at least one criterion.

15. The computing system of claim 9, wherein the computing system further comprises the camera.

16. A computer-readable storage medium having program instructions stored thereon that, when executed by at least one processor, direct the at least one processor to perform a method, the method comprising:
displaying content on an extended reality device;
capturing, by a camera, a reflection from an eye of a user, the camera configured to identify changes to pixels in the reflection asynchronously; and
detecting a movement of the eye based on a change to at least one pixel detected in the reflection.

17. The computer-readable storage medium of claim 16, wherein the method further comprises:
determining a brightness of the content; and
modulating at least one light source based on the brightness satisfying at least one criterion.

18. The computer-readable storage medium of claim 16, wherein the method further comprises:
determining a brightness of the content; and
updating the content with at least one content element based on the brightness satisfying at least one criterion.

19. The computer-readable storage medium of claim 16, wherein the method further comprises:
determining that a quantity of light from a physical environment satisfies at least one criterion; and
modulating the light from the physical environment in the extended reality device based on the quantity of the light satisfying the at least one criterion.

20. The computer-readable storage medium of claim 16, wherein the method further comprises:
determining an expected reflection based on the content; and
comparing the expected reflection to the reflection to detect the change to the at least one pixel.
